(19) United States
(12) Patent Application Publication
(10) Pub. No.: US 2022/0012911 A1
(43) Pub. Date: Jan. 13, 2022

(54) SYSTEM AND METHOD FOR ANALYZING AN IMAGE TO DETERMINE SPACING BETWEEN A PERSON AND AN OBJECT

(71) Applicant: UNITED STATES POSTAL SERVICE, Washington, DC (US)

(72) Inventors: Andrew TOWNSEND, Clifton, VA (US); David LIN, Merrifield, VA (US); Barry E. RUSSELL, Falls Church, VA (US); Roger WORNER, Saint Peters, MO (US)

(21) Appl. No.: 17/373,847

(22) Filed: Jul. 13, 2021

Related U.S. Application Data
(60) Provisional application No. 63/050,990, filed on Jul. 13, 2020.

(51) Int. Cl. G06T 7/73; G08B 21/18; G05B 15/02

(52) U.S. Cl. CPC G06T 7/74; G06T 2207/30196; G05B 15/02; G08B 21/182

(57) ABSTRACT

A computer-implemented system, method and computer-program product are configured to receive an image of a location from at least one image sensor device; analyze the image to determine a distance between a person and an object in the image; and output a control signal when the determined distance between the person and the object is below a predetermined threshold distance. The control signal causes an electronic device at the location to perform an action related to the distance between the person and the object. The object may be another person.

### CROSS-REFERENCE TO RELATED APPLICATIONS

This application claims the benefit of, and priority to, U.S. Provisional Patent Application 63/050,990, which was filed on Jul. 13, 2020, and is incorporated herein by reference in its entirety.

### BACKGROUND

In an environment, location, or area where people are present, assuring adequate distance between a person and an object or between a person and another person or persons may be important. For example, if one person is present in an area such as when using or interfacing with an object, such as an automated postal center (APC) machine or the like, it may be important for privacy and/or security reasons to prevent other persons from coming too close to the person and/or the object. Such an environment or location could be indoor or outdoor in a retail, work, home, entertainment, service or other environment, for example.

Also, assuring adequate distancing between people in an area may be important for health reasons. For example, social distancing to allow adequate spacing between persons may be needed to minimize chances of transmitting diseases from one person to another, in addition to other reasons.

### SUMMARY

In one example aspect, a system may include a processor, a computer readable memory, a non-transitory computer readable storage medium associated with a computing device, and program instructions executable by the computing device. The program instructions are configured to cause the computing device to perform operations including: receiving an image of a location from at least one image sensor device; analyzing the image to determine a distance between a person and an object in the image; and outputting a control signal when a the determined distance between the person and the object is below a predetermined threshold. The control signal may be configured to control a controlled device in a manner related to the determined distance between the person and the object.

In another example aspect, a computer program product includes a computer readable storage medium having program instructions embodied therewith. The program instructions are executable by a computing device to cause the computing device to perform operations including receiving an image of the location from at least one image sensor device; analyzing the image to determine a distance between a person and an object in the image; and outputting a control signal when the determined distance between the person and the object is below a predetermined threshold. The control signal may be configured to control a controlled device in a manner related to the determined distance between the person and the object.

In another example aspect, a method includes receiving an image of a location from at least one image sensor device; analyzing the image to determine a distance between a person and an object in the image; and outputting a control signal when the determined distance between the person and the object is below a predetermined threshold. The control signal may be configured to control a controlled device in a manner related to the determined distance between the person and the object.

In some aspects of the system, the computer program product and the method, the object is another person. In some aspects of the system, the computer program product and the method, the control signal is used to control an object to prevent other persons from entering a spacing within the predetermined threshold to the person.

In some aspects of the system, the computer program product or the method, the control signal is configured to generate an indicator or a warning to maintain sufficient distance between the person and other persons to be above the predetermined threshold.

### BRIEF DESCRIPTION OF THE DRAWINGS

FIG. 1 illustrates an overview of an example a captured image of a location in accordance with aspects of the present disclosure.

FIG. 2 illustrates example components of a system that may be used in conjunction with the image and location of FIG. 1.

FIG. 3 illustrates an example implementation that utilizes a plurality of control signals to control a plurality of devices in accordance with aspects of the present disclosure.

FIG. 4 illustrates an example flowchart of a process for determining a distance between a person relative to an object, and generating a control signal when the determined distance is less than a predetermined threshold.

FIG. 5 illustrates an example flowchart of a process for determining a distance between a person relative to an object, and generating a control signal when the determined distance is less than a predetermined threshold.

### DETAILED DESCRIPTION

Certain embodiments of the disclosure will hereafter be described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current disclosure.

Accurately measuring a distance between a person in a location and an object by analyzing an image of the location having the person and the object can be done by known techniques. For example, an image can be analyzed to identify a person or persons in an image, to determine a distance between an image sensor (such as a camera) taking the image of the location and to determine a distance between an object in the image and the image sensor, and to determine a distance between the person and the object in the image. The term object, as used herein, may refer to an animate object or person (e.g., a customer, an employee, etc.) or to a physical inanimate object such as a terminal, a computerized kiosk, an APC, an automated teller machine (ATM), an area of customer-service counter space, a door, or any other item. In various embodiments, the location may be almost any area that is imaged by the image sensor. For example, the location may be an inside public space, such a store interior, a lobby, or the like (e.g., a Post Office retail lobby or other postal facility), the location may be an inside non-public (e.g., employee-only) space, such a back work area, a production floor, an office area, a pantry, or the like (e.g., a Post Office sorting facility or area), or the location may be an outside public or non-public space, such as a sidewalk, a storefront, a loading dock, etc., among other things.

Additionally, methods and techniques are known for detecting persons and other objects in an image. One method that can perform such detection of objects in an image is YOLO (You Only Look Once), which may be used with embodiments described herein.

As described herein, a system, method and computer program product of embodiments may receive an image of a location having a person and an object depicted therein, determine a distance between the person and the object, and generate a control signal when the determined distance between the person and the object is less than a predetermined threshold. The control signal is configured to control a device in or near the location, for example, to cause the device to perform an action. In some embodiments, the action may be to generate a warning indicator regarding the determined distance, as further described herein.

Embodiments of the disclosure may include a system, a method, and/or a computer program product at any possible technical detail level of integration. The computer program product may include a computer readable storage medium (or media) having computer readable program instructions thereon for causing a processor to carry out aspects of the present disclosure.

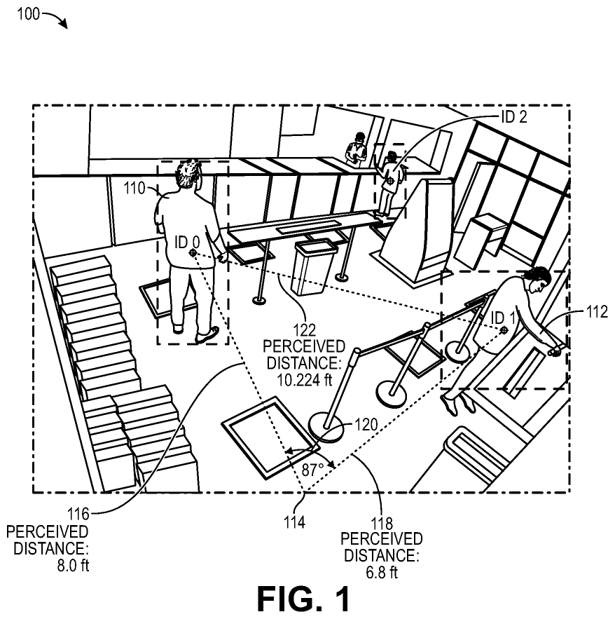

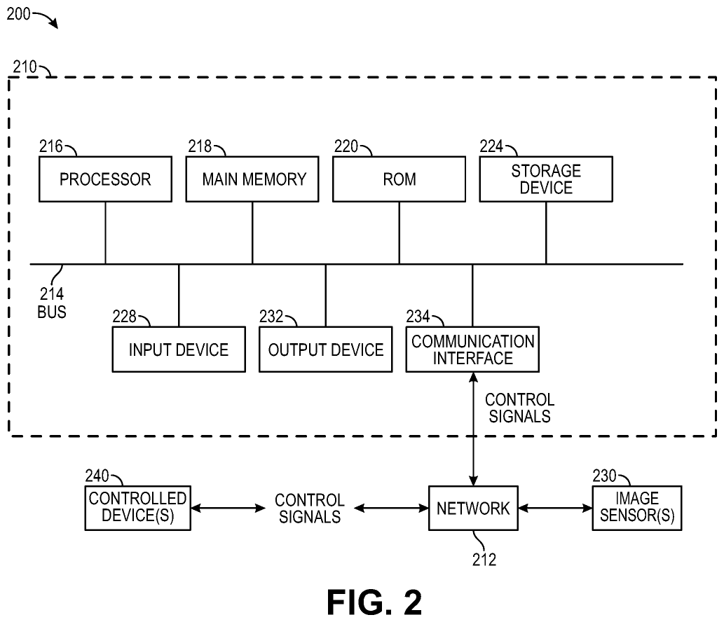

FIG. 1 shows an example a captured image 100 of a location in accordance with aspects of the present disclosure. The image 100 shows a first person 110 (ID 0) and a second person 112 (ID 1) and is captured by an image sensor (not shown), such as a camera that is disposed approximately at position 114. The image sensor captures the image which is sent to the system 200 (FIG. 2) for analysis. The system 200 analyzes the image 100 to determine a position of the first person 110 and to determine a distance 116 from the position of the image sensor to the first person 112. The distance 116 (and the distance from the position of the image sensor and objects in the image) can be determined by known computer techniques. For example, it is known that the distance D between an object and an image sensor (e.g., a video camera) can be determined by calculating the distance D (e.g., in mm) as being equal to the focal length of the image sensor (mm) times (multiplied by) the estimated or known height of the object (mm) times the height of the image (in pixels) divided by the object height (in pixels) times the height of the image sensor (mm) above the ground or floor.

In FIG. 1, using the above, the distance from the position 114 of the image sensor to person 110 is calculated or determined based on the known focal length of the image sensor, the height in pixels of the person 110 as determined from the image (here 218 pixels), the height of the image in pixels, the height of the image sensor in mm, and the height of the person 110 in mm. From these values, the distance 116 was determined as 8.0 feet. In some embodiments, an average person's height may be used as the height of a person, such as 5 foot 9 inches (1752 mm) for a U.S. male or 5 foot 4 inches (1626 mm) for a U.S. female, or some other value. For some objects that are always going to be present in an image where the camera is in a fixed location, such as a customer-service counter or an APC, the height of the object may be preprogrammed into a memory of the system 200 to be used in the calculations.

In FIG. 1, a second distance from the position 114 of the image sensor to person 112 is calculated or determined in a same way, now using the height in pixels of 139 pixels to determine distance 118 as 6.8 feet. The image sensor may be programmed to output an angle 120 (or angle 120 may be calculated or determined by the system) between the directions or lines 116, 118 used to measure the distances to the first person 110 and to the second person 112. Techniques for calculating or determining angles between lines/directions in a digital image are well know in the digital image processing art. The angle 120 in this example was determined to be 87 degrees.

In various implementations, the system 200 may calculate or otherwise determine the distance 122 between the first person 110 and the second person 112 using known trigonometric techniques, such as the law of cosines, and the previously calculated distances 116, 118 and angle 120. For example, the distance 116 has been determined as 8.0 feet, the distance 118 has been determined as 6.8 feet, and the angle 120 has been determined as 87 degrees, so the system 200 can calculate the distance 122 between the first person 110 and the second person 112 using a trigonometry equation where distance 122 squared equals (6.8) squared+(8.0) squared−(2) (6.8) (cos 87 degrees), or distance 122 squared=46.24+64−2(6.8) (8) (0.05233595624)=10.244 feet.

Embodiments use this method to calculate the distance between a person and an object (where the object may be another person or a physical object) by; (1) determining the distance between the position of the image sensor and the person, (2) determining the distance between the position of the image sensor and the object, (3) determining an angle between the first direction or line from the image sensor to the person and the second direction or line from the image sensor to the object, and (4) using the distances and angle to calculate the distance between the person and the object. If there is no angle between the first and second direction lines (they are the same direction), then the first distance may be simply subtracted from the second distance to determine the difference, because the cosine of zero degrees is one.

In some embodiments where the distance determined by the system 200 is between a first person and a second person, the determined distance between the persons is compared to a predetermined threshold and a control signal is generated if the distance is equal to, or equal to or less than the predetermined threshold, which may be referred to as a distancing threshold violation. For example, in embodiments that are using the system 200 in the context of social distancing, the threshold may be six feet (or some other value). The control signal may be used to notify, alert, or generate an indicator to one or more of the persons that their spacing is too close, and/or that they should increase their spacing, as further explained herein.

In some embodiments, the distances between each pair of any number of persons in the image may be individually determined or calculated. In such embodiments, a control signal may be generated when the distance or spacing between any of the pairs of persons is below a predetermined threshold.

In other embodiments where the system 200 determines the spacing or distance between a person and a physical object, the system 200 generates the control signal when the spacing is less than the predetermined threshold, the control signal may be configured to control a device, as further explained herein.

FIG. 2 illustrates an example of a system 200 that may be used to implement various embodiments described herein. The system 200 includes a computing device 210 capable of communicating via a network, such as the network 212. In example embodiments, the computing device 210 may correspond to or be a mobile communications device (e.g., a smart phone or a personal digital assistant (PDA)), a portable computer device (e.g., a laptop or a tablet computer), a desktop computing device, a server, etc. In some embodiments, the computing device 210 may host programming and/or an application to determine the distance between a person and an object as discussed herein and to generate the control signal or otherwise control an electronic device when the distance is determined to meet one or more specified criteria, such as the being less than or equal to a predetermined threshold distance. The computing device 210 is configured to receive or otherwise obtain an image(s) (e.g., video images) of a location (e.g., a retail lobby, a work room, an area of a manufacturing floor, etc.) from an image sensor 230 positioned, mounted, or installed at, in, or near the location.

As shown in the example of FIG. 2, the computing device 210 may include a bus 214, a processor 216, a main memory 218, a read only memory (ROM) 220, a storage device 224, an input device 228, an output device 232, and a communication interface 234.

Bus 214 may include a path that permits communication among the components of device 210. Processor 216 may include a processor, a microprocessor, an application specific integrated circuit (ASIC), a field programmable gate array (FPGA), or another type of processor that interprets and executes instructions. Main memory 218 may include a random access memory (RAM) or another type of dynamic storage device that stores information or instructions for execution by processor 216. ROM 220 may include a ROM device or another type of static storage device that stores static information or instructions for use by processor 216. Storage device 224 may include a magnetic storage medium, such as a hard disk drive, or a removable memory, such as a flash memory.

Input device 228 may include a component that permits an operator to input information to device 210, such as a control button, a keyboard, a keypad, or another type of input device. Output device 232 may include a component that outputs information to the operator, such as a light emitting diode (LED), a display, or another type of output device. Communication interface 234 may include any transceiver-like component that enables device 210 to communicate with other devices or networks. In some implementations, communication interface 234 may include a wireless interface, a wired interface, or a combination of a wireless interface and a wired interface. In embodiments, communication interface 234 may receive computer readable program instructions from a network and may forward the computer readable program instructions for storage in a computer readable storage medium (e.g., storage device 224).

System 200 may perform certain operations, functions, processes, or methods, as described in detail below. System 200 may perform these operations in response to processor 216 executing software instructions contained in a computer-readable medium, such as main memory 218. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into main memory 218 from another computer-readable medium, such as storage device 224, or from another device via communication interface 234. The software instructions contained in main memory 218 may direct processor 216 to perform processes, functions, and/or operations that will be described in greater detail herein. Alternatively, hardwired circuitry may be used in place of or in combination with software instructions to implement processes described herein. Thus, implementations described herein are not limited to any specific combination of hardware circuitry and software.

In some implementations, system 200 may include additional components, fewer components, different components, or differently arranged components than are shown in FIG. 2.

The network 212 may include one or more wired and/or wireless networks. For example, the network 212 may include a cellular network (e.g., a second generation (2G) network, a third generation (3G) network, a fourth generation (4G) network, a fifth generation (2G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 212 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In embodiments, the network 212 may include copper transmission cables, optical transmission fibers, wireless transmission, routers, firewalls, switches, gateway computers and/or edge servers.

The computing device 210 shown in FIG. 2 may be programmed to receive or obtain an image that includes the person and the object, determine a distance between the person in the image and the object based on or using the image, and generate the control signal(s) when the determined distance between the person and the object meets one or more specific criteria, such as being less than or violating a predetermined threshold distance, such as six feet.

The system 200 may be configured to receive or obtain images from one image sensor 230 or from a plurality of image sensors 230. The image sensors 230 may be placed to capture images from or of a single location, in which case the images from the different image sensors 230 may capture images of the same persons and/or objects. The images from the separate image sensors 230 may be separately analyzed to individually calculate or determine the distance between the person and the object in the images. In these embodiments, a control signal may be generated if any of, or the average of, the determined distances between the person and the object fall(s) below (is less than) the predetermined threshold distance.

Additionally, in some embodiments, the system 200 may utilize more than one criteria, (e.g., multiple predetermined threshold distances) to trigger a control signal(s), where the different thresholds can be utilized for different situations. For example, a first threshold could be used for comparison to the system 200's calculated distance between a first person and an object that is a second person. In this situation, the first threshold could be 6 feet, for example, in accordance with the Center for Disease Control guidelines for social distancing. A second threshold could be used for comparison to the calculated distance between a person and an inanimate object, that is, an object this is not a person or other living creature. In this situation, the second threshold could be different from the first threshold. For example, the second threshold could be three feet (or some other value), as social distancing guidelines are not applicable for inanimate objects.

In some embodiments, the image sensors 230 may be placed at different locations to capture images of different persons and objects that do not overlap among the locations. In these embodiments, the system 200 may be configured to individually calculate distances between a person and one or more objects in each image, and to generate control signals in association with each of the different locations/sensors when the distances are determined to be less than a predetermined threshold. Additionally, the system 200 may be configured to use and/or store a plurality of thresholds (which may be different from each other), with each threshold corresponding to a particular image sensor/location and/or to a specific situation or individual use.

For example, the system 200 may utilize three image sensors 230, with two of the image sensors configured to capture images of a first location, and the third image sensor configured to capture images of a second location different from the first location. The images captured by the first and second image sensors 230 may have one corresponding threshold stored in memory 218 that is used for comparison with the determined distances at the first location, and the third image sensor 230 may have a different corresponding threshold stored in memory 218 that is used for comparison with the determined distances at the second location.

In various embodiments, the system 200 may have one or more prestored control signals for use in controlling a single controlled device 240 when the determined distances or less than the predetermined threshold, or for use in controlling multiple controlled devices 240 when the triggering condition(s) (e.g., threshold condition) is met.

In some embodiments, the predetermined threshold may be set by a user of the system, such as by input through input device 228.

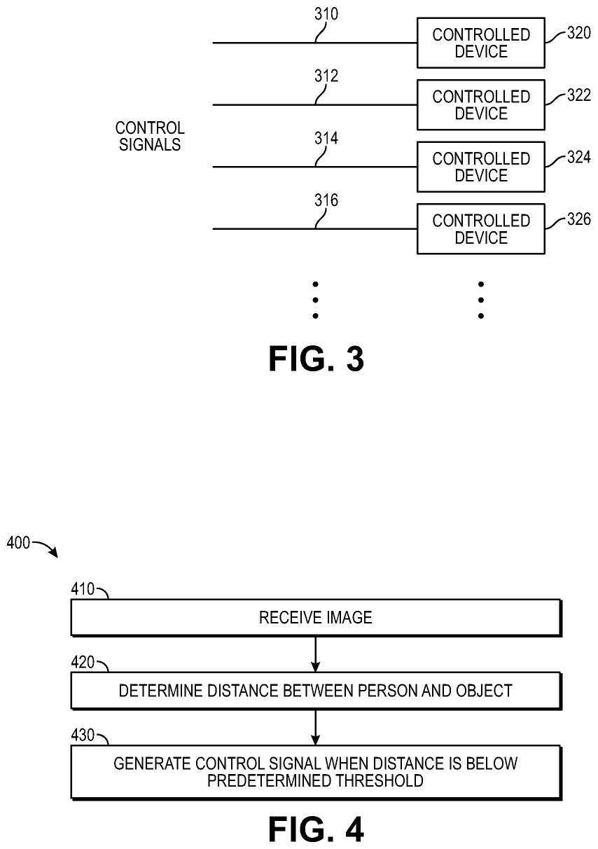

FIG. 3 illustrates a plurality of controlled devices controlled by a plurality of control signals. Controlled devices 320, 322, 324, 326, etc. may be controlled by separate control signals 310, 312, 314, 316, etc. The controlled devices 320, 322, 324, 326, etc. may be controlled by the control signals based on one or more images from one image sensor 230 at one location, or based on a plurality of images from a plurality of images sensors 230, where the image sensors 230 are disposed in one location or in a plurality of locations. For example, controlled device 320 and controlled device 322 could both receive control signals that are generated by the system 200 based on one or more images from a single image sensor 230.

The controlled device 320 could be a first type of controlled device while the second controlled device 322 could be a same type of controlled device or a different second type of controlled device. As one example, the first controlled device 320 could be a display device, such as a computer monitor or the like, and the second controlled device 322 could be an interactive device, such as an APC or the like. In this example, the first controlled device 320, in response to a control signal(s), can be used to display information, generate sound, and/or otherwise provide an indication (e.g., a message regarding increasing the spacing between people) to one or more persons. Similarly, in response to a control signal(s) from the system 200, the second controlled (interactive) device 322 can be commanded to perform a desired action—for instance, the interactive APC device can be commanded to power down or enter a standby mode. Thus, upon determining that a first person has come within a predetermined threshold distance of the interactive APC device (or other object), the system 200 may send a control signal(s) to power down one or more adjacent interactive APC devices to prevent or discourage other persons from approaching or using the adjacent kiosks or terminals, which would bring the other persons within the threshold distance of the first person.

In some embodiments, both of the control signals could be generated based on one or more images from a single image sensor 230, where the image sensor 230 can obtain images that can be analyzed to determine spacing between the persons in the location being imaged and to determine spacing between one or more of the persons and the object.

In other embodiments, the controlled device 320 could be controlled based on a control signal 310 sent based on one or more images from a first image sensor 230, and the controlled device 322 could be controlled based on a control signal 312 sent based on one or more images from a second image sensor 230. The first and second image sensors could be disposed at one location or at two different locations. For example, the first controlled device 320 could be a display device controlled by control signal 310 to display and/or audibly play an indication regarding spacing of one or more persons at a first location based on an image from the first image sensor, and the second controlled device 322 could be a same type of controlled device or a different type of controlled device controlled by control signal 312 generated in response to an image from the second image sensor.

The controlled device 240, 320-326 could be any type of device that can respond to a control signal. In various embodiments, the controlled device 240,320-326 may be a device that can communicate (e.g., notify or indicate via text, sound, video, etc.) with a specific person, or with more than one person, regarding distancing or spacing, including the distance or spacing between a specific person and another person or between a person and an object, and the like. For example, the controlled device could be a display device (e.g., a monitor or a TV) that is controlled via a control signal 310-316 to display and/or announce a message to the persons in a location, where the message may include an indication that the persons are too close together, and should increase the distance between themselves.

In various implementations, the controlled device 240, 320-326 could be a display or audio device (e.g., a cell phone, a radio, a walkie talkie, etc.), an electronic device such as a cellphone, a laptop or other computer, a compute stick, a self-service or other kiosk device or terminal, an APC, an ATM or other banking machine, a personal electronic device (such as a an electronic tablet), a gaming machine (slot machine), etc. Additionally, the controlled device 240, 320-326 could be a device that is perceivable by the person(s) that is violating the spacing criteria, (e.g., is within a threshold distance or another person), such as a display or audio device to generate a message or other indicator regarding spacing to the entire location, or the controlled device may be a device that directs an indicator to a person other than the person that is violating the spacing criteria, such as an employee at a retail location. For example, a controlled device may indicate to an employee that customers are not maintaining spacing above the threshold, and the employee may be directed to take some corrective action regarding the distance spacing, such as asking the person(s) that is violating the spacing criteria to increase their spacing.

In some embodiments, the controlled device 240, 320-326 may be a device that can control access to an imaged area or location, such as a door control device that can selectively allow or prohibit access to an area, e.g., an electronic lock or an electronic enter/do not enter sign over a door.

For example, in accordance with aspects, the system 200 may evaluate whether or not distancing criteria (e.g., threshold(s)) are being met based on the number or the frequency of distancing threshold violations. For example, in some embodiments, the system 200 may analyze images continuously to detect distancing threshold violations and use each violation to calculate the number of violations per minute and/or the total number of violations. If the total number of violations or the number of violations per minute exceeds a predetermined maximum or a predetermined frequency threshold, such as three violations per minute, then the system 200 may generate and transmit a control signal 310-316 to a door control device 240 (e.g., an electronic lock or an electronic sign that can be commanded to display “do not enter”) to prohibit additional people from entering the area. Subsequently, the system 200 may generate and transmit a control signal 310-316 to the door control device 240 to unlock the door or change the sign to “enter” after a predetermined amount of time or upon detecting that the number of violations per minute falls below the predetermined frequency threshold.

For another example, in accordance with aspects, the system 200 may evaluate whether or not distancing criteria (e.g., threshold(s)) are being met based on the number of people currently in the area/location. For example, in some embodiments, the system 200 may analyze images to detect and count the number of people in the area/location at the same time. If the total number of people exceeds a predetermined threshold number, such as two people (e.g., for a small area), then the system 200 may generate and transmit a control signal 310-316 to a door control device 240 to prohibit additional people from entering the location. Subsequently, the system 200 may generate and transmit a control signal 310-316 to the door control device 240 allow additional people to enter upon detecting that the number of people in the location is less than the predetermined threshold number (e.g., after someone leaves the location). Such embodiments are useful, for example, when the controlled-access location is of a size where adequate spacing between persons is not possible when more than two persons enters the area, which may be due to the small size of the area, such as a 10×10 foot foyer. Similarly, there may be some smaller locations where the predetermined threshold number is one, such that only one person at a time should be in the location.

In embodiments, an object as described herein could be a service counter such as the service counters found in a retail or postal establishment, and the system 200 may analyze the images to determine when a customer moves within a predetermined distance of the service counter. In such embodiments, the generated control signal(s) may cause a controlled device 240 (e.g., an employee monitor, cell phone, pager, or the like) to generate an indicator that a customer is at the service counter, such as a message to an employee that a customer at the counter needs service, and/or the control signal(s) may cause a controlled device 240 to generate a message to the customer.

In various embodiments, the system 200 may evaluate whether or not distancing criteria (e.g., threshold(s)) are being met at a location such as a work floor (e.g., a USPS sorting center work floor, where USPS workers are moving mail from one sorting machine to another and to/from loading docks, etc.). The system 200 may evaluate spacing between each of the workers and generate a control signal when a spacing between any of the workers drops below a predetermined threshold distance. The system 200 may be configured to recognize each worker in an image by analysis of the image (such as by facial recognition) or by other means, such as by an identifier carried by the workers that can be recognized by the system 200.

The control signal may be configured to control a controlled device in a manner related to the spacing between the workers having dropped below the predetermined threshold. For example, each worker may have on his person an electronic device such as a cell phone, a pager, a USPS networked scanner, a compute stick or the like. In this embodiment, the system detects when one of the USPS workers moves into violation of the distancing threshold with respect to another worker, and then notifies one or both of those workers, such as via their electronic device, to move apart a distance greater than the predetermined threshold. In various embodiments, the controlled device may be another type of device as described herein configured to provide an indicator to the workers regarding the distancing violation. For example, the controlled device could be a video display to provide a visual indicator, a speaker device to provide an audio indicator, or any of the other types of controlled devices described herein.

FIG. 4 illustrates an example flowchart of a process for determining the distance between a person and an object from an image depicting the person and the object, and generating a control signal when the distance is less than a predetermined threshold. The blocks of FIG. 4 may be implemented using the systems and components described with respect to FIGS. 1 and 2, for example, and are described using reference numbers of elements depicted in FIGS. 1 and 2. The flowchart illustrates the architecture, functionality, and operation of possible implementations of systems, methods, and computer program products according to various embodiments of the present disclosure.

As shown in FIG. 4, process 400 may include receiving or obtaining an image (block 410). For example, the computing device 210 may receive an image from an image sensor 230 (e.g., a camera device). In some embodiments, the image sensor 230 may be configured to capture images continuously (e.g., video images) or at a set interval (e.g., every 0.5 second, every 1 second, every 2 seconds, or the like), or an application or programmed instruction may be configured to direct the image sensor to capture images of a location continuously or at a set interval.

Process 400 also may include determining a distance between a person in the image and an object in the image (block 420). For example, the processor 216 runs instruction stored in the memory 218 to analyze the image to identify a person, and determine a distance between the person and an object in the image, as further described herein.

Process 400 further may include generating a control signal when the determined distance between the person and the object is below a predetermined threshold (block 430). For example, the processor 216 may carry out programmed instructions to generated a control signal when the determined distance between the person and the object is less than a predetermined threshold distance, such as 6 feet. The control signal is configured to be sent to and control a device(s) 240, as further described herein. In various implementations, the control signal may control the device 240 in a manner that causes the device 240 to perform one or more action, operation, or function that is related to the detected violation of the predetermined threshold distance, as further described herein, such as notifying the relevant person(s) about the distancing violation, etc.

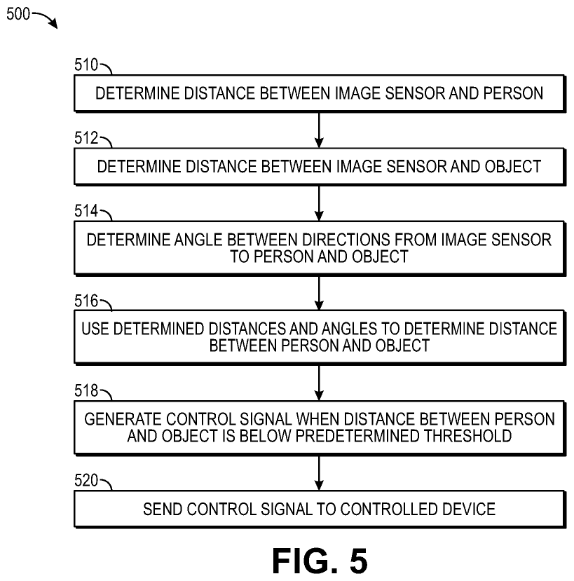

As shown in FIG. 5, process 500 shows an example of further details that may be carried out in embodiments described herein. In various embodiments, the process 500 may be implemented using a computing device, such as in the system 200 of FIG. 2, which may have at least an image sensor(s) (e.g., camera) 230 deployed in a location as shown in the example of FIG. 1. The process 500 may include calculating or determining a distance between the image sensor 230 and a person (e.g., the person 110) in an image (e.g., the image 100) captured by the image sensor (block 510). For example, the image sensor 230 may capture an image having a person and an object depicted therein, and the image may be sent to the computing device 210 over network 212. The processor 216 is configured to run instructions stored in the memory 218 to analyze the image to determine the distance between the person in the image and the image sensor, for example, based on pixel size, camera focal length, camera mounting position, and an average or known height of an object or person in the image, as described previously.

Process 500 further may include calculating or determining a distance between the image sensor 230 and an object (e.g., the person 112) in the image (e.g., the image 100) (block 512). For example, the processor 216 may be configured to run instructions stored in the memory 218 to determine the distance between the image sensor 230 and an object in the image. In some embodiments, the object may be another person and/or a physical object such as an electronic device (e.g., an APC) or a customer-service counter, as further described herein.

Process 500 also may include calculating or determining an angle between a first direction or line from the image sensor 230 to the person (e.g., direction line 116 of FIG. 1) and a second direction or line (e.g., direction line 118 of FIG. 1) from the image sensor 230 to the object (block 514). For example, the processor 216 may run instructions stored in the memory 218 to determine the angle from the captured image (block 514). When the first and second directions are the same, this step may be omitted.

Process 500 further may include calculating or determining a distance (e.g., the distance 122) between the person in the image and an object in the image using the distance between the image sensor and the person, the distance between the image sensor and the object and the angle between the first and second directions (block 516). For example, the processor 216 may be configured to run instructions stored in the memory 218 to use the determined distances and angle to determine the distance between the person and the object depicted in the image. As noted previously, the calculations of block 516 may be implemented using trigonometry.

Process 500 also may include generating, selecting, or otherwise determining a control signal when the determined distance between the person and the object is less than a predetermined threshold distance (block 518). For example, the processor 216 may be configured to run instructions stored in the memory 218 to generate the control signal when the determined distance is less than the predetermined threshold distance, as further described herein.

Process 500 further may include sending or otherwise providing the control signal to a controlled device (block 520). For example, the processor 216 may be configured to run instructions stored in the memory 218 to send the control signal to a controlled device. In some embodiments, the control signal can be sent to a controlled device 240 over network 212, as further described herein.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may include a system, a method, and/or a computer program product at any possible technical detail level of integration. The computer program product may include a computer readable storage medium (or media) having computer readable program instructions thereon for causing a processor to carry out or execute aspects and/or processes of the present disclosure.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a user's computer, partly on the user's computer, as a stand-alone software package, partly on the user's computer and partly on a remote computer or entirely on the remote computer or server.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In embodiments, a service provider could offer to perform the processes described herein. In this case, the service provider can create, maintain, deploy, support, etc., the computer infrastructure that performs the process steps of the disclosure for one or more customers

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While the present disclosure has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the disclosure.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A computer-implemented method of determining a position of a person relative to an object, the method comprising:
receiving an image of a location from an image sensor, the image depicting the person and the object;
analyzing the image to determine a distance between the person and the object;
comparing the determined distance between the person and the object to a predetermined threshold distance; and
outputting a control signal when the determined distance is less than the predetermined threshold distance, whereby the control signal is configured to control a controlled device in a manner related to the determined distance between the person and the object.

2. The method of claim 1, wherein the object is a second person.

3. The method of claim 1, whereby the control signal is configured to control a controlled device in a manner related to increasing the determined distance between the person and the object.

4. The method of claim 1, wherein the controlled device is one or more of a personal electronic device, a display terminal, an audio device, and a kiosk device.

5. The method of claim 1, further comprising receiving a plurality of images from the image sensor, analyzing each of the images to determine a distance between a person and an object, and outputting a control signal when the determined distance between the person and the object in any of the images is below a corresponding threshold.

6. The method of claim 1, further comprising receiving at least one image from each of a plurality of image sensors, analyzing each of the images to determine a distance between a person and an object in the corresponding image, and outputting a corresponding control signal when the determined distance between the person and the object in any of the images is below a corresponding threshold.

7. The method of claim 1, wherein the location is a postal facility, the object is a second person, and the controlled device is a device configured to generate a warning indication to the person and/or to the second person.

8. The method of claim 1, wherein the location is a postal facility, the object is a terminal device, and the controlled device is a second terminal device that is controlled by the control signal to be turned off.

9. A computer program product comprising a computer readable storage medium having program instructions embodied therewith, the program instructions executable by a computing device to cause the computing device to perform operations comprising:
receiving an image of a location from an image sensor, the image depicting a person and an object;
analyzing the image to determine a distance between the person and the object;
comparing the determined distance between the person and the object to a predetermined threshold; and
outputting a control signal when the determined distance is less than the predetermined threshold, whereby the control signal is configured to control a controlled device in a manner related to the determined distance between the person and the object.

10. The computer program product of claim 9, wherein the object is a second person.

11. The computer program product of claim 9, whereby the control signal is configured to control a controlled device in a manner related to increasing the determined distance between the person and the object.

12. The computer program product of claim 9, wherein the program instructions executable by the computing device cause the computing device to further perform operations comprising receiving a plurality of images from the image sensor, analyzing each of the images to determine a distance between a person and an object, and outputting a control signal when the determined distance between the person and the object in any of the images is below a corresponding threshold.

13. The computer program product of claim 9, wherein the program instructions executable by the computing device cause the computing device to further perform operations comprising receiving at least one image from a plurality of image sensors, analyzing each of the images to determine a distance between a person and an object in the corresponding image, and outputting a corresponding control signal when the determined distance between the person and the object in any of the images is below a corresponding threshold.

14. The computer program product of claim 9, wherein the controlled device is one of a personal electronic device, a display terminal, an audio device, and a kiosk device.

15. The computer program product of claim 9, wherein the location is a postal facility, the object is a second person, and the controlled device is a device configured to generate a warning indication to the person and/or to the second person.

16. A system comprising:
a processor, a computer readable memory, a non-transitory computer readable storage medium associated with a computing device, and program instructions executable by the computing device to cause the computing device to perform operations comprising:
receiving an image of a location from an image sensor, the image depicting a person and an object;
analyzing the image to determine a distance between the person and the object;
comparing the determined distance between the person and the object to a predetermined threshold; and
outputting a control signal when the determined distance is less than the predetermined threshold, whereby the control signal is configured to control a controlled device in a manner related to the determined distance between the person and the object.

17. The system of claim 16, wherein the object is a second person.

18. The system if claim 16, whereby the control signal is configured to control a controlled device in a manner related to increasing the determined distance between the person and the object

19. The system of claim 16, wherein the controlled device is an electronic device configured to convey an indicator to a person related to the determined distance.

20. The system of claim 16, whereby the control signal is configured to control a plurality of controlled devices in a manner related to the determined distance between the person and the object.
